(19) United States
(12) Patent Application Publication
(10) Pub. No.: US 2016/0117924 A1
(43) Pub. Date: Apr. 28, 2016

(54) SECURITY DASHBOARD

(71) Applicant: MOVEINSYNC TECHNOLOGY SOLUTIONS PVT LTD, Bangalore (IN)

(72) Inventors: Vishwastam SHUKLA, BANGALORE (IN); SOURAV AGARWAL, Gwalior (IN); CHANDRA MOHAN MEENA, Deoli (IN); KANIKA KAPOOR, BANGALORE (IN)

(21) Appl. No.: 14/577,512

(22) Filed: Dec. 19, 2014

(30) Foreign Application Priority Data
Oct. 24, 2014 (IN) 5281/CHE/2014

(51) Int. Cl. G08G 1/123

(52) U.S. Cl. CPC G08G 1/123

(57) ABSTRACT

A security alert system for providing real time security alerts comprises a device storing and sending data. A tracking platform server receives data from the device and sends data to a messaging service. A tracking server is provided for receiving data from the messaging service. The tracking server has business logic for processing data received from the tracking platform server. The tracking server monitors data and raise alert if the required condition is satisfied. A client side component is included for interacting with a customer through a browser. The client side component polls to the tracking server to get a new alert or status of the existing alert. The client side has a configuration part wherein the user can configure an alert condition.

This application claims the benefit and priority to Indian Application Serial No. 5281/CHE/2014 entitled “SECURITY DASHBOARD,” filed on Oct. 24, 2014, the contents of which is hereby incorporated by reference.

### BACKGROUND OF THE DISCLOSURE

1. Technical Field of the Disclosure

The present invention is related in general to security alert systems, and in particular to a security alert system for providing security alerts in vehicles based on analysis of data from various devices.

2. Description of the Related Art

Various types of security alert systems are available for tracking and monitoring vehicles and concerned with safety of people inside the vehicles. There are different types of security alert systems which have been defined based on analysis on data received from different devices. Mostly, call box system and two-way radio transmission systems are employed in emergency vehicles and sometimes in mass transportation carriers which are expensive and time consuming.

There are various types of Global Positioning System (GPS) locating devices that may be used in vehicles. A GPS locating system can be useful, but there are limitations with respect to vehicle theft and recovery applications. These vehicle recovery systems would be useful if they provide improved theft detection and vehicle location awareness and monitoring so as to identify unauthorized movement and assist in recovery.

Some of the security alert systems only allow for manual system activation and/or deactivation, requiring the vehicle owner to hold and depress certain switches on a transmitter. Such manual operation is both inconvenient and dangerous. Other systems provide only limited alarm functionality, thereby successfully preventing or deterring only a relatively small number of thefts while being easily disconnected or deactivated by a thief and providing an alarm only when the vehicle has actually been damaged.

In a known prior art related to security alert systems, the systems provide a single signaling unit carried by an individual, object, or vehicle. If the signaling unit is separated from the individual, object, or vehicle, tracking is no longer possible and the system fails. Moreover, these systems fail to address the circumstances of individuals who are helpless in an emergency situation such as abduction or kidnapping, or physical or mental incapacitation.

One of the existing security alert systems includes a communication subsystem which is configured to provide two-way wireless communication, and a controller mounted on a vehicle and configured to receive data indicative of a location of the vehicle and to control the communication subsystem to transmit the data indicative of the vehicle location toward a remote communication center and receive operational information transmitted from the remote communication center. The controller receives a mode change command included in the operational information and in response changes operating mode between an authorization mode, in which the controller transmits an alert signal to the remote communication center, and a tracking mode, in which the controller transmits the data indicative of vehicle location continuously at predetermined intervals regardless of the authorization signal. However, the system does not provide real time security alerts.

Recent advancements in the prior art discloses a vehicle tracking system that includes a vehicle position identifying system and a controller. The position identifying system determines the vehicle's location and provides it to the controller. The controller compares the location information with schedule information and the real or elapsed time information and provides output indicating whether the vehicle is ahead of, behind or on schedule. The system would be complex, difficult to install and expensive.

Based on the foregoing there is a need for a security alert system that would provide real time security alerts. Such a system would provide effective monitoring by providing security alerts based on analysis of data. Further, such a needed alert system would provide a system that would allow a user to configure the alert condition. Finally, such a needed system would be less complex, economic and easy to install. The present invention overcomes prior art shortcomings by accomplishing these critical objectives.

### SUMMARY OF THE DISCLOSURE

To minimize the limitations found in the prior art, and to minimize other limitations that will be apparent upon the reading of the specifications, the preferred embodiment of the present invention provides a security alert system which receives alert through business intelligence logic on data which is received from a device to a client side component.

The present invention discloses a security alert system for providing real time security alerts. The security alert system comprises a device for storing and transferring data. The device polls periodically to a tracking platform server in a predetermined time interval, (preferably, every 45 seconds) and sends data. The data is milestone data which has real time tracking data which includes global positioning system (GPS) current location, GPS last location, network location and device identification.

The tracking platform server receives data from the device and sends data to a tracking server from the device and sends data to a messaging service. The tracking platform server is a first point of contact for the device to send milestone data and to send message/command to the device. The tracking server is provided for receiving data from the messaging service and having business logic for processing data received from the tracking platform server. The tracking server processes data using business logic and analyses if any alert is required to be raised. The tracking server provides application programming interface (API) to client-side logic to call periodically and fetch alert if it exists.

The security alert system comprises a client side component for interacting with a customer through browser. The client side component polls in every 45 seconds to the tracking server to get a new alert or status of the existing alert. The client side having a configuration part from where a user can configure an alert condition.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a flow diagram illustrating the flow of data in a security alert system, in accordance with various embodiments of the invention; and

FIG. 2 is a flow chart illustrating the processing of data and raising alert signals in a security alert system, in accordance with various embodiments of the invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

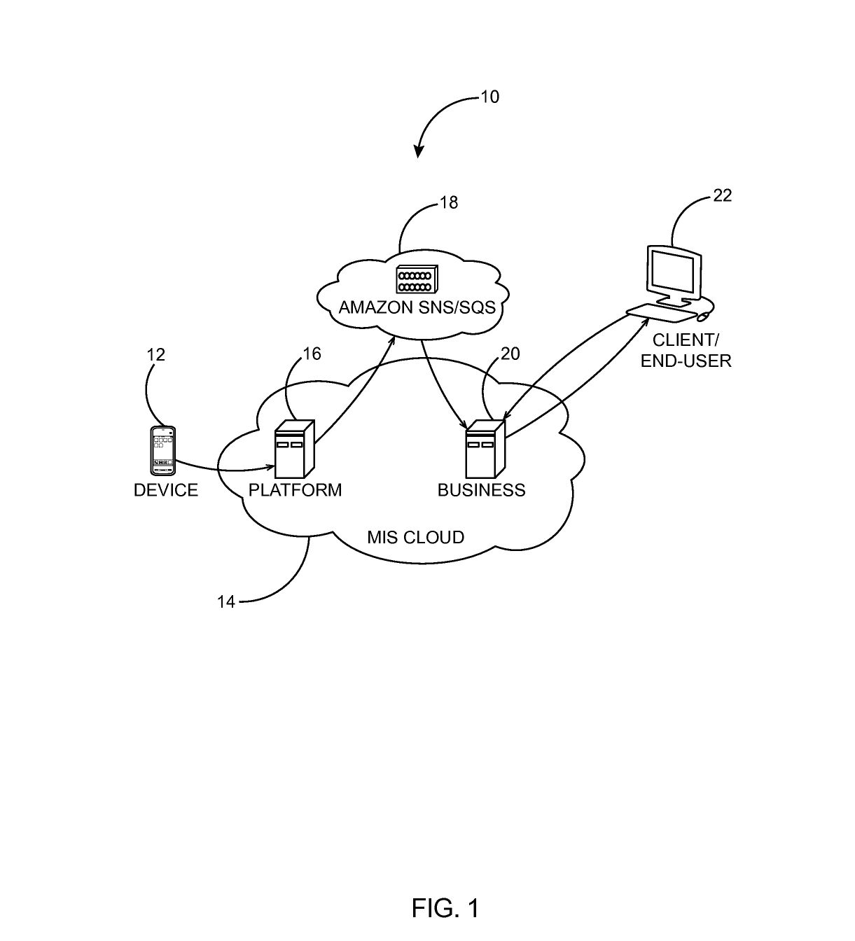

FIG. 1 is a flow diagram illustrating the flow of data in a security alert system 10 from a tracking device 12 to a client, in accordance with various embodiments of the invention. The security alert system 10 comprises the tracking device 12 for storing and sending data. The tracking device 12 polls periodically to a tracking server 16 in a predetermined interval of time, preferably every 45 seconds and sends milestone data. Milestone data has real time tracking data which includes global positioning system (GPS) current location, GPS last location, network location and device identification. The tracking server 16 is provided for receiving data from the device and sending data to a messaging service 18 i.e., via Amazon Simple Notification Service/Simple Queue Service (SNS/SQS). The tracking server 16 is a first point of contact for the device to send milestone data, and also to send message/command to the tracking device 12. The security alert system 10 require to listen message from the tracking device 12 and send the tracking device 12 command for network reset, so there is a bi-directional communication with the tracking device 12 through tracking server 16. The tracking server 16 is required to send command to the tracking device 12 in very rare situations.

The security alert system 10 includes a receiver 20 or business for receiving data from the messaging service. The tracking server 16 and the receiver 20 form a management information system (MIS) cloud 14. The receiver 20 has business logic to process data received from the tracking server 16 via SNS/SQS to analyze and figure out if an alert is required to be raised.

For example, there are different types of alert conditions such as Over-Speeding alert, Device-Not-Reachable alert, Vehicle-Stoppage alert, User-Sign-Off-Time-Violation alert, User-Sign-Off-Location-Violation, Platform, Business etc. If a vehicle is running more than a client's specified safe speed then Over-Speeding alert is raised. This alert indicates the client that driver is running the vehicle more than the speed which is not considered safe by them. If the device does not send data to a server for more than x minutes then Device-Not-Reachable alert is raised. This alert indicates that the android device is not connected with the system, so there may be possible prospect of threat to user. If a vehicle is not moving for more than x minutes then we raise Vehicle-Stoppage alert. This alert indicates the client about the status of the vehicle and if the vehicle is not moving then it falls into the category of security threat to a user. If the user does not sign off before x time then User-Sign-Off-Time-Violation alert is raised. If a user does sign off from x distance of his end location User-Sign-Off-Location-Violation alert is raised. Platform or Tracking Platform Server alert indicates that the device communicates with the platform for most of the scenarios to send data for tracking, user-sign in/sign off, trip starts/ends and driver sign in/sign off etc. Finally, Business or User Transport Server alert indicates major chunk of our business logic of the client. The tracking server provides application programming interface (API) to client side logic to call periodically and fetch the alert if it exists.

The security alert system 10 also includes a client side component for interacting with a customer through a browser. The client-side polls in every 45 seconds to the tacking server to get a new alert or the status of existing alert. The client-side is a view part of the security alert. The client side has a configuration part from where user can configure the alerts condition. For example, a user can set a threshold value of time to raise device not reachable alert. The security alert system receives data from the device to the tracking platform server via general packet radio service (GPRS) and from the tracking platform server to the tracking server via a messaging service and the tracking platform server monitors data and raises alert conditions.

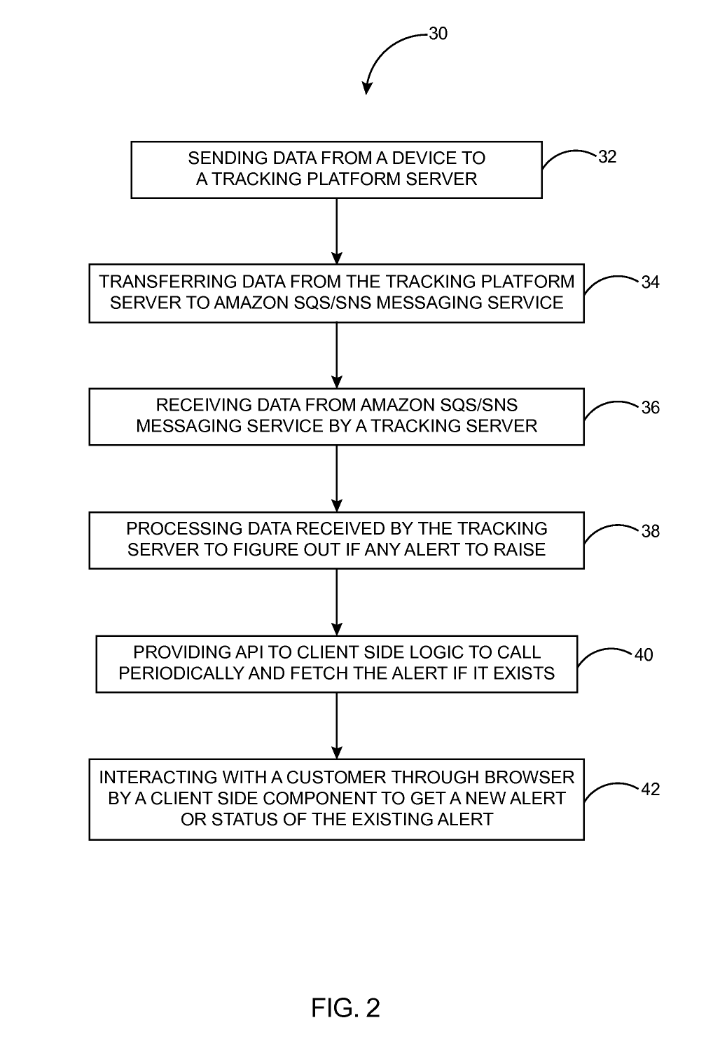

FIG. 2 is a flow chart illustrating the processing of data and raising alert signals in a security alert system, in accordance with various embodiments of the invention. The flowchart initiates at step 30. At step 32, the data is sent from a device to a receiver. The data from the receiver is transferred to a messaging service i.e. via Amazon Simple Notification SNS/SQS at step 34. At step 36, data is transferred from the messaging service to a tracking server. The data which is received by the tracking server via SNS/SQS is processed by the tracking server to figure it out if an alert is to be raised as illustrated at step 38. The tracking platform server is provided with an application programming interface (API) to client-side logic to call them periodically and fetch the alert if it exists as explained at step 40.

Further, at step 42, the client-side component is provided to interact with a customer through browser. The client-side polls are configurable and for instance, here in every 45 seconds to the tracking server to get a new alert or the status of the existing alert. The client-side is view part of the security alert system. The client side has a configuration part from where user can configure the alerts condition.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A system for providing notifications in transport management, the system comprising:
a. a tracking device installed in one or more vehicles configured to monitor the one or more vehicles, wherein the tracking devices retrieve tracking data related to the one or more vehicles and wherein the tracking is done on a pre-determined route;
b. a receiver configured to receiving tracking data, wherein the tracking data is received from tracking device installed in one or more vehicles;
c. a tracking server configured to:
i. process the received tracking data, wherein the processing is done in order to determine one or more alerts to be raised, wherein the one or more alerts to be raised are for one or more pre-configured threshold; and
ii. generating one or more notifications related to the one or more alerts raised; and
d. a transmitter configured to:
i. send the received tracking data to the tracking server; and
ii. send the one or more notifications to one or more users, wherein the communicating of notifications is done at pre-determined intervals of time.

2. The system as claimed in claim 1, wherein the receiver is further configured to receive feedback from the one or more users, wherein the feedback is in response to the one or more notifications.

3. The system as claimed in claim 1, wherein the tracking device collects real time tracking data, wherein the tracking data comprises the route taken by the vehicle.

4. The system as claimed in claim 1, wherein the notification is sent to the one or more users in real-time,

5. The system as claimed in claim 1, wherein the notifications are sent on a dashboard application.

6. The system as claimed in claim 1, wherein the dashboard is an interface provided to the user.

7. The system as claimed in claim 1, wherein the one or more pre-configured threshold comprise vehicle stoppage beyond a pre-configured time period, over speeding of the vehicle beyond pre-determined limits, device not reachable beyond pre-determined time, delay in alighting time, incorrect alighting location and the like.

8. A computer program product for displaying a dashboard application on each of a plurality of computing devices, wherein, the dashboard application when executed, is configured to display graphical representation of tracking data retrieved from one or more vehicles, characterized in that, the dashboard application is configured to provide notifications to the one or more users associated with each of the plurality of computing devices.
